(19) United States
(12) Patent Application Publication
(10) Pub. No.: US 2026/0026991 A1
(43) Pub. Date: Jan. 29, 2026

(54) BODY SUPPORT AND POSITIONING DEVICE FOR SPINAL OPERATIONS

(71) Applicant: SebiEpi LLC, East Hampton, NY (US)

(72) Inventor: Lisa Marie Goldsmith, East Hampton, NY (US)

(21) Appl. No.: 19/280,800

(22) Filed: Jul. 25, 2025

Related U.S. Application Data
(60) Provisional application No. 63/675,625, filed on Jul. 25, 2024.

(51) Int. Cl. A61G 13/12

(52) U.S. Cl. CPC A61G 13/122; A61G 13/129

(57) ABSTRACT

A support and positioning device used for spinal anesthesia procedure includes a body, an arm rest, a chin rest, and a handle. The arm rest and/or chin rest may be removably attached to the body. Moreover, the arm rest and the chin rest may be adjustable in height and manufactured in varied sizes and shapes. In some embodiments, the handle comprises two hand straps with adjustable height. The support device may also comprise a disposable or washable outer cover with a waterproof zipper, such that the outer cover can be removed from the body to allow for easy disinfection and reuse of the support device in hospital or other health care settings.

### CROSS REFERENCE TO RELATED APPLICATIONS

This application claims the benefit of priority under 35 U.S.C. § 119 (e) of U.S. Provisional Patent Application Ser. No. 63/675,625, filed Jul. 25, 2024, the entire disclosure of which is hereby incorporated by reference

### FIELD

The disclosure relates generally to body support and positioning devices and particularly to such devices for use in spinal medical operations.

### BACKGROUND

Spinal anesthesia procedures, such as spinal taps, lumbar punctures, epidural injections and facet joint injections, are common in medical operations. In these procedures, patients must, in many cases, sit or lie down and remain in a still position, enduring a certain level of pain and discomfort, throughout the entire operation period.

Traditionally, medical staff may require or recommend that patients hold a sleeping pillow during operations of this kind to avoid excessive movement. However, because of the softness of sleeping pillows, it is difficult for patients to remain still while holding the pillow, and sleeping pillows do not provide sufficient support to patients.

Other devices such as positioning chairs may also be provided to patients. While these chairs are generally rigid enough to support patients in certain positions, they typically cannot accommodate a wide range of sizes and positions of patients. The chairs are also not suitable to be used by patients with certain special conditions, such as, for example, pregnant patients in labor, who need a larger space for their abdominal area and are frequently in too severe pain to move off from a hospital bed. Some chairs are also designed to position patients facing forward, such that the backrest of the chair blocks access to the back side (i.e., posterior aspect) of the patient's anatomy.

Thus, there has long been a need in the art for a flexible, portable, supportive device suitable to a wide range of patients' shapes and sizes.

### SUMMARY

There is an unmet need for body support devices used in spinal anesthesia medical procedures and operations, especially spinal operations and any operation that requires spinal tap or epidural, or lumbar puncture, which are portable, sturdy, easy to clean, comfortable for patients to hold and rest on, and suitable for various body sizes and shapes. These and other needs are addressed by the various embodiments and configurations of the present disclosure.

It is one aspect of various embodiments of the present disclosure to provide a device that both supports a patient and conforms to the patient's body shape during spinal operations. In some embodiments, a support device comprises a body, an arm rest, and a chin rest. When in use, a patient may hug the body of the support device in front of them, placing their chest and abdominal areas against a back surface of the body. Further, the patient may wrap their arms around the central body of the pillow where the arm indentions are, resting their arms on the arm rest and positioning their chin on or in the chin rest. This position provides strong support to the patient's upper body without blocking any back surface for the convenience of medical staff performing spinal anesthesia procedures.

It is one aspect of various embodiments of the present disclosure to ensure portability of the body support device. In various embodiments, a support device comprises a one-piece structure filled with lightweight materials selected from the group consisting of shredded memory foam, micro bead, polyester fiberfill, buckwheat hull, kapok, latex, and combinations thereof. Depending on the choice of material used to construct the device, a total weight of the device may be about four pounds, light enough for patients of a wide variety of different sizes and figures, including children/pediatric patients, to carry.

In addition, various embodiments of the body support device may have a total width of about 18-22 inches (depending on embodiment), a height of about 23-28.6 inches (depending on embodiment), and a thickness of about 5 inches to about 8 inches. One advantage of providing a portable support device is that it is easy for patients to carry the device while positioned on different surfaces. For example, a pregnant patient in labor may be positioned on an edge of a bed to receive epidural injection, whereas in other operations, a patient may be positioned on chairs or tables for spinal operations. Further, in various scenarios, medical staff may relocate or reposition their patients to access the ultimate injection site.

Various embodiments further comprise a carved-out chin rest located on a top of the main body. Besides the chin resting function, the carved-out structure results in a lower device weight, which improves the portability of the device.

One aspect of various embodiments of the present disclosure is to provide sufficient support for patients during spinal anesthesia procedure. In some embodiments, the support device comprises a body filled with one or more memory foams, an indented chin rest and arm indentations and/or arm rest protruding from the body, and optionally at least one handle. The combination of the arm rest and the at least one handle allows patients to easily hold and hug the support device firmly.

In other embodiments, the at least one handle further comprises two straps located above the arm rest, thereby forming two loops, allowing patients to easily and securely grab the support device. One advantage of this feature is to prevent the patient's hands and arms from slipping off of the cushion, especially when patients are in pain and may writhe or otherwise be in continual and/or constant motion.

In some embodiments, the at least one handle comprises one or more adjustable straps that allow patients to secure their hands by a fastening mechanism, e.g., one or more adjustable buckles. This feature is especially useful for patients in extreme pain or who can exert only a weak grabbing force (e.g., have poor grip strength or hand strength) due to certain medical conditions. The fastened handle allows patients to secure the pillow without applying a strong force to hold the strap or grab the pillow.

In some other embodiments, the main body further comprises a chin rest located on the top of the body, allowing patients to rest their chins on top of the support device and secure their chins, thus preventing side-to-side movements of the patient's head.

One aspect of many embodiments of devices according to the present disclosure is that the device may be easy to clean, which makes the device especially suitable for medical hygiene needs. In some embodiments, the cushion comprises an outer cover, wherein the outer cover further comprises a waterproof zipper so that the outer cover is removable from the insert. Further, the cover is made with waterproof and/or heat-resistant materials selected from the group consisting of tissue, polyester, polypropylene, spunbonded polypropylene, spunlance, spunbond, and any combination of the abovementioned materials. Such structure and material(s) allow hospital staff to clean and disinfect the cushion efficiently by removing the cover and cleaning the cover together with other soiled hospital linens. In some other embodiments, the outer body cover is disposable and constructed of materials selected from the group consisting of tissue, polyester, polypropylene, spunbonded polypropylene, spunlance, spunbond, and any combination of the abovementioned materials. A disposable cover may be suitable for one-time use to avoid infections and other biohazards presented by biological fluids (e.g., blood, amniotic fluid, pus, spinal fluid, etc.).

Another advantage of embodiments of the cushions/support devices of the present disclosure is flexibility in suiting different body sizes (e.g., adults vs. children/pediatric patients) and positions (e.g., standing, sitting, prone, supine, etc.). Considering the cushion is used for various spinal anesthesia procedures by patients in labor and other physical conditions, adjustable size is highly desired.

In some embodiments of the present disclosure, the arm rest is removably attached to the main body by attaching mechanisms such as zippers, snaps, loops, hooks, hook-and-loop fasteners (e.g., VELCRO®), or the like. When in use, patients and medical staff may casily vertically reposition the arm rest (i.e., move the arm rest upwardly or downwardly) to suit the patients' needs. A patient may also choose to use the cushion without the arm rest on the body. Further, female patients may choose to use the arm rest as a breast rest by turning the arm rest toward themselves and resting their breast on top of the arm rest. In some other embodiments, the at least one handle is removably attached to the main body and includes looped straps with adjustable loop size and position, thereby supporting and securing patients' hands regardless of the size of the patient's hands.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The embodiments and configurations described herein are neither complete nor exhaustive. As will be appreciated, other embodiments are possible utilizing, alone or in combination, one or more of the features set forth above or described in detail below.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various embodiments of the disclosure, as illustrated by the drawings referenced below.

FIG. 1 illustrates a front view of an embodiment of a support device, in accordance with one or more embodiments of the present disclosure;

FIG. 2 illustrates a left view of an embodiment of the support device of FIG. 1A;

FIG. 3 illustrates a sectional view of an embodiment of the support device of FIG. 1A;

FIG. 4 provides a front view of a support device, in accordance with one or more embodiments of the present disclosure;

FIG. 5 provides a side view of the support device of FIG. 4;

FIG. 6 provides a back view of the support device of FIG. 4;

FIG. 7A provides a front view of the support device of FIG. 4 when being held by a user;

FIG. 7B provides a side view of the support device of FIG. 4 when being held by the user;

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment since describing every possible embodiment of the support device would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the support device can be combined with dimensions, aspects, and features of another embodiment of the support device to create the claimed embodiment.

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

A number of variations and modifications of the foregoing disclosure can be used. It would be possible to provide for some features of the disclosure without providing others.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving case and/or reducing cost of implementation.

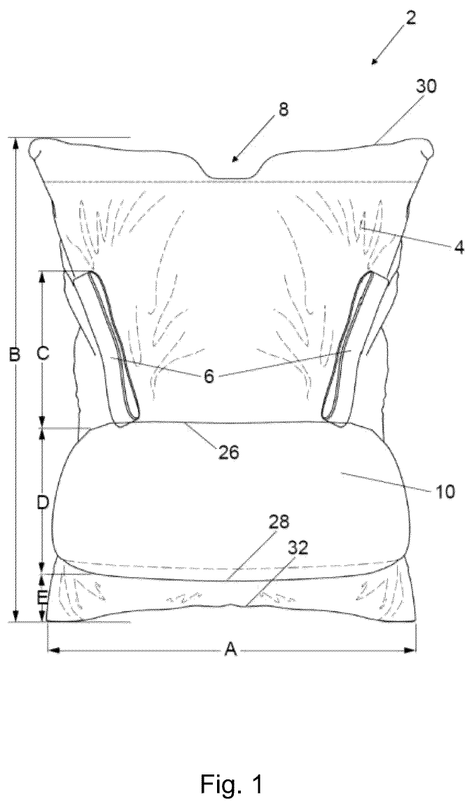

FIG. 1 is a front view of at least one embodiment of a support device 2 having a body 4, a chin rest 8, at least one handle 6, and an arm rest 10. The at least one handle 6 may further comprise two or more hand straps. The body 4 generally defines the outer extent of the support device 2. In this embodiment, the body 4 is formed in a rectangular prism with a width A approximately 18 inches and a height range from 26 inches to 30 inches, suitable for an adult. It is to be appreciated that the dimensions of the body may vary in different embodiments. Some of the embodiments of the support device are configured to be used by a minor or an adult with a smaller figure or frame; by way of non-limiting example, embodiments of devices according to the present disclosure may have a width ranging from about 14 inches to about 16 inches and a height ranging from about 18 inches to about 22 inches.

In the embodiment illustrated in FIG. 1, the arm rest 10 is placed at the front side of the body 4. In this embodiment, the arm rest 10 is a trapezoidal prism-shaped feature that protrudes from the front surface of the body 4; it is to be expressly understood that the arm rest may take any other suitable shape. The arm rest comprises an upper end 26 and a lower end 28, wherein the width of the upper end 26 is smaller than the width of the lower end 28. As illustrated in FIG. 1, the lower end 28 is proximate to the bottom 32 of the body 4, and in this embodiment, a height D of the arm rest 10 (i.e., a distance between the upper end 26 and the lower end 28) is approximately 6 inches. The lower end 28 of the arm rest 10 is spaced from the bottom 32 of the body 4 by a distance E, which in this embodiment is approximately 2.5 inches.

Additionally, in the embodiment illustrated in FIG. 1, the handle 6 is placed above the arm rest 10. Here, the handle 6 comprises two hand straps, which are arranged to align with two axes of the support device 2 that are at an oblique angle to each other. It is to be appreciated that in some embodiments, the two hand straps may be placed parallel to each other. The hand straps are constructed of materials selected from the group consisting of leather, polypropylene, polyester, and combinations thereof. In the present embodiment, the height C between the upper end of the handle 6 and the upper end 26 of the arm rest is approximately 8 inches.

The support device 2 may further comprise a chin rest 8 carved out from the body 4 at a top of the body 4. The chin rest 8 may be formed by cutting out a portion of the body along the entire thickness and/or lateral axis of the body 4, such that a thickness of the chin rest is equal to a thickness of the body 4, and a height of the chin rest may be from about 2 inches to about 3 inches.

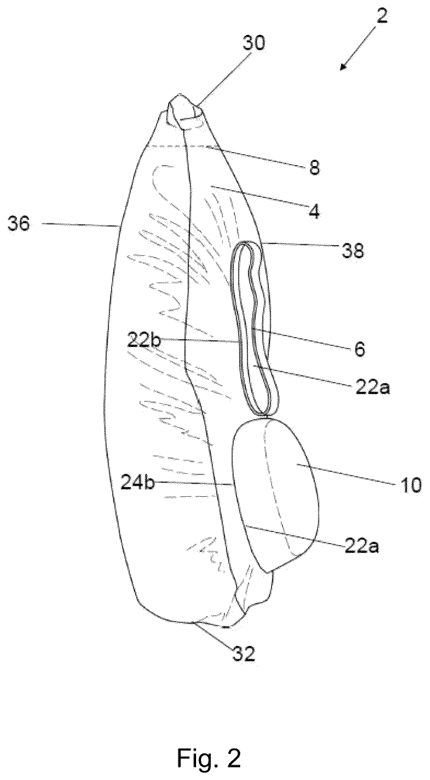

FIG. 2 illustrates a left view of an embodiment of a support device 2, wherein the support device 2 comprises a back surface 36 and a front surface 38. The front surface 38 is attached to an arm rest 10 and a handle 6. The front surface 38 and the back surface 36 define the thickness of the body 4, wherein the body 4 extends from the from the front surface 38 to the back surface 36 along a longitudinal axis; as illustrated in FIG. 2, the support device 2 has a contoured or tapered shape, such that the thickness generally increases from the top 30 to the bottom 32 of the support device.

In this embodiment, the hand strap 6 is attached to the body 4 by a first attaching mechanism 22. Specifically, in the assembly of the support device 2, an attaching component 22a is placed on the hand strap 6, and an attaching component 22b is placed on the body 4. The attaching components 22a and 22b can then be connected such that the hand strap 6 is attached and secured to the body 4. Typically, the first attaching mechanism 22 may be selected from the group consisting of hook and loop material sold under the trademark VELCRO®, zippers, snaps, buttons, clasps, and combinations thereof. In some embodiments, the handstraps may be fixed directly to the body, e.g., by sewing/stitching, adhesive, heat-pressing, or the like.

Similarly, the arm rest 10 in this embodiment is attached to the body by a second attaching mechanism 24, wherein the second attaching mechanism further comprises arm rest attaching components 24a and 24b. Specifically, in the assembly of the support device 2, an attaching component 24a is placed on the arm rest 10 and an attaching component 24b is placed on the body 4. To attach and secure the arm rest 10 to the body 4, a user or manufacturer may simply connect the attaching component 24a and the attaching component 24b. Typically, the second attaching mechanism 24 may be selected from the group consisting of hook and loop material sold under the trademark VELCRO®, zippers, snaps, buttons, clasps, and combinations thereof. In some embodiments, the arm rest may be fixed directly to the body, e.g., by sewing/stitching, adhesive, heat-pressing, or the like.

FIG. 2 further illustrates a chin rest 8 placed proximate to the top of the body 4 and cut throughout the entire thickness of the body 4, i.e., extending from the back surface 36 of the body 4 to the front surface 38 of the body 4. It is to be appreciated that in some embodiments, the chin rest may be cut into only a portion of the thickness of the body 4; for example, the chin rest 8 may extend from the back surface 36 across less than all of the thickness of the body 4, i.e., without reaching the front surface 38.

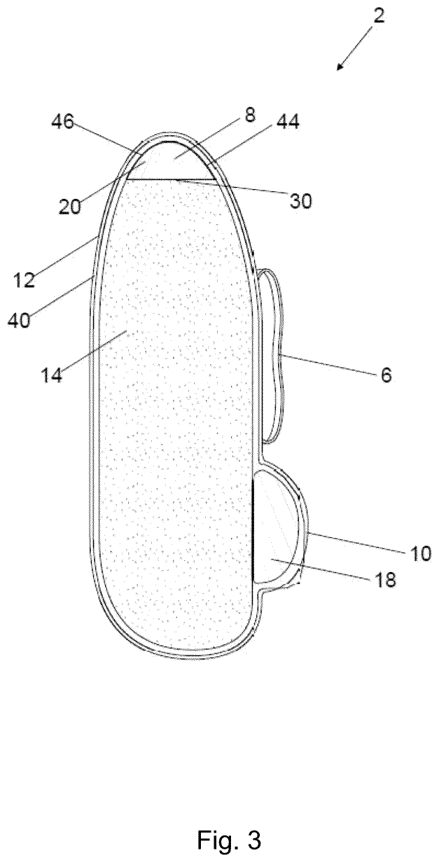

FIG. 3 illustrates a sectional right view of an embodiment of the support device 2 that comprises one or more inserts. Specifically, in this embodiment, the support device comprises a first insert 20 for the chin rest 8, a second insert 18 for the arm rest 10, and a third insert 14 for the body 4. Still more specifically, in this embodiment, the first and second inserts 20 and 18 are configured with materials selected from the group consisting of LUX foam, high density foam, memory foam, organic cotton batting, and poly foam, or any combination of the abovementioned materials. The third insert 14 is constructed of materials selected from the group consisting of shredded memory foam, non-toxic memory foam, micro bead, polyester fiberfill, buckwheat hull, kapok stuffing, and latex stuffing, and any combination of the abovementioned materials. It is to be appreciated that the inserts may also be constructed of a single material or of two or more materials. In some embodiments, the support device comprises only one insert constructed of a single material for the chin rest, body, and arm rest structures. Yet in other embodiments, one component, for example, a chin rest 8, may comprise two or more inserts constructed of various materials.

The support device 2 illustrated in FIG. 3 also comprises one or more covers. In this embodiment, the support device comprises a cover 12 covering the chin rest 8, the arm rest 10, and the body 4. In this embodiment, the cover 12 is constructed of materials selected from the group consisting of polyester knitted jersey, vinyl, PVC mackintosh materials, brushed microfiber, organic cotton with a waterproof barrier, waterproof polyurethane membrane, NaturSoft PU rayon backed upholstery, and any combination of the abovementioned materials. In some embodiments, the cover 12 may further comprise an opening and a waterproof zipper capable of opening and closing the opening. In yet other embodiments, the cover 12 may be replaceable and constructed of disposable materials, including, but not necessarily limited to, tissue, polyester, polypropylene, spunbonded polypropylene, spunlance, and any combination of the abovementioned materials. It is to be appreciated that in yet other embodiments, a support device may be constructed as a one-piece device comprising a chin rest, a body, and an arm rest, wherein the chin rest, the body, and the arm rest are all covered by a first cover. It is also appreciated that in some embodiments, a support device may comprise a first cover covering a chin rest and a body, and a second cover covering an arm rest insert, wherein the first cover and the second cover each include an attaching mechanism configured to attach the arm rest to the body. In such embodiments, patients and physicians may remove the arm rest from the body easily without opening the first cover for the body. In some embodiments, the first and second covers may be constructed of materials selected from the group consisting of polyester knitted jersey, vinyl, PVC mackintosh materials, brushed microfiber, organic cotton with a waterproof barrier, waterproof polyurethane membrane, NaturSoft PU rayon backed upholstery, and any combination of the abovementioned materials. In yet other embodiments, the first and the second covers may be replaceable and constructed of disposable materials, including, but not necessarily limited to, tissue, polyester, polypropylene, spunbonded polypropylene, spunlance, and any combination of the abovementioned materials.

In some embodiments, the support device further comprises an inner cover 40 disposed between the first cover 12 and the body 4 and/or between the second cover 16 and the arm rest 10, if applicable, wherein the inner cover 40 is constructed of any one or more suitable materials, including, but not necessarily limited to, cotton, microfiber, linen, and any combination of the above-mentioned materials.

FIG. 3 further illustrates a support device 2 wherein a chin rest 8 is separately constructed from a body 4. In this embodiment, the support device 2 comprises a body 4 with a top 30, wherein a chin rest 8 is attached to the top 30 and placed above the top 30. The chin rest 8 may further comprise a slot 42 extending from a second end 44 to a first end 46 of the chin rest 8. In some embodiments, the chin rest slot 42 only partially cutting through the chin rest. For example, the slot 42 may extend from the second end 46 towards the first end 44 without reaching the second end 46, resulting in a blocking volume proximate to the first end 44 of the chin rest. The chin rest 8 is further attached to the body 4 through a chin rest attaching mechanism, wherein the chin rest attaching mechanism further comprises a fifth attaching component placed on the chin rest 8, and a sixth attaching component placed on the top 30 of the body 4. The chin rest attaching mechanism is selected from the group consisting of zipper, a hook and loop material, buttons, snap fasteners, and combinations thereof.

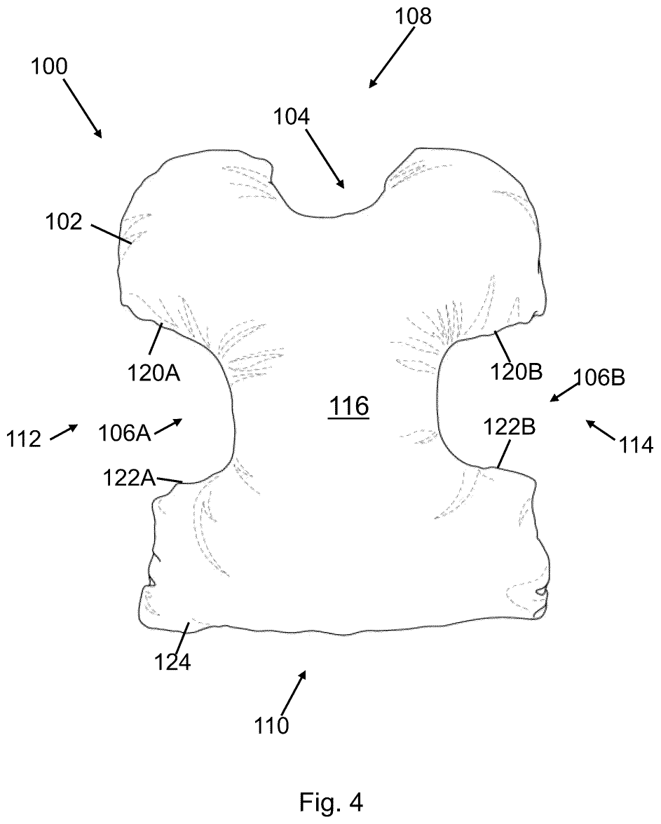

FIGS. 4-6 illustrate a support device 100 in accordance with one or more embodiments of the present disclosure.

In embodiments, the support device 100 has a body 102, which includes a chin rest 104 and at least one arm rest 106. The body 102 generally defines the outer extent of the support device 100. In this embodiment, the body 102 is formed in a rectangular prism with a width A approximately 18-22 inches and a height range from 23 inches to 30 inches, suitable for an adult and/or a child. It is to be appreciated that the dimensions of the body may vary in different embodiments. Some of the embodiments of the support device are configured to be used by a minor or an adult with a smaller figure or frame; by way of non-limiting example, embodiments of devices according to the present disclosure may have a width ranging from about 14 inches to about 16 inches and a height ranging from about 18 inches to about 22 inches. It is also appreciated that, because support device 100 is constructed at least partially of deformable materials, users may change the size of the support device 100, for example, by squeezing the support device 100, to better suit their figure.

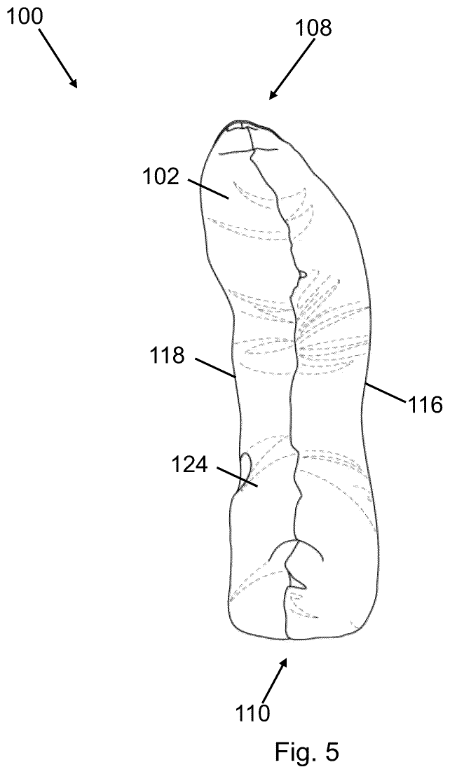

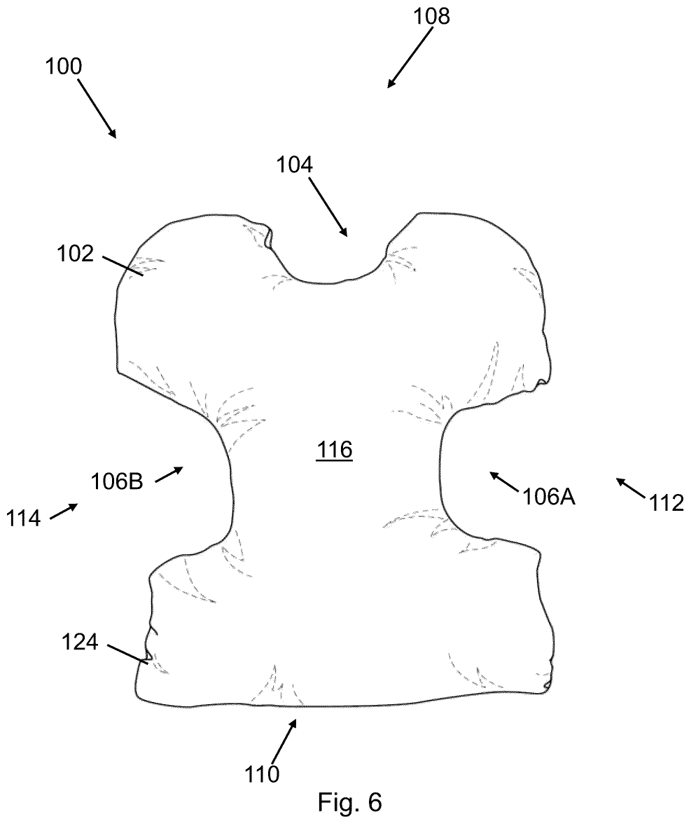

In the embodiment, as shown in FIGS. 4 and 6, the body 102 has a first end 108 and a second end 110 opposite to the first end 108 in a vertical dimension along a height of the support device 100. The body 102 further has a first side 112 and a second side 114 opposite to the first side 112 in a longitudinal dimension along a width of the support device 100. The body 102 extends between the first and second ends 108 and 110 vertically, and between the first side 112 and the second side 114 longitudinally. The body further has a front surface 116 and a back surface 118 (as shown in FIGS. 5-6), where the body extends between the front and back surface 116 and 118 laterally, defining a thickness of the support device.

In the non-limiting embodiment, the chin rest 104 is constructed as a cutout at the first end 108 of the support device 100. The chin rest 104 has a first width, where the first width is smaller than a width of the body 102 at the first end 108. In the non-limiting embodiment, the first width of the chin rest 104 is approximately 5 and 5/16 inches (5.3125″). The chin rest 104 further has a height of approximately 3 inches. In the non-limiting embodiment, as shown in FIG. 5, the chin rest 104 further cuts throughout the entire thickness of the body 102, i.e., extending from the back surface 118 of the body 102 to the front surface 116 of the body 102. It is to be appreciated that in some embodiments, the chin rest may be cut into only a portion of the thickness of the body; for example, the chin rest may extend from the back surface across less than all of the thickness of the body, i.e., without reaching the front surface.

In embodiments, the at least one arm rest 106 is placed at the sides 112 and 114 of the body 102. In this embodiment, the at least one arm rest 106 includes a first arm rest 106A at the first side 112 of the body 102 and a second arm rest 106B at the second side 114 of the body 102. In the non-limiting embodiment, the arm rests 106 are constructed as cutouts at the side of the body. It is to be expressly understood that the arm rest may take any other suitable shape. The arm rest comprises an upper end 120 and a lower end 122. As illustrated in FIGS. 4 and 6, the first and second arm rests 106A and 106B are approximately centered in the height of the body 102, where the distance from the first end 108 of the body to the upper end 120 of the arm rest is approximately equal to the distance from the lower end 122 of the arm rest to the second end 110 of the body. Further, in this embodiment, a height of the arm rest 106 (i.e., a distance between the upper end 120 and the lower end 122) is approximately 7.5 inches. The lower end 122 of the arm rest 106 is spaced from the second end 110 of the body 102 by a distance of approximately 6.75 inches.

FIG. 5 illustrates a left side view of an embodiment of a support device 100, where the thickness of the device between the front surface 116 and the back surface 118 varies along the height of the body 102. In this embodiment, the body 102 reaches a maximum thickness between the first end 108 and the upper end 120 of the arm 106 (as shown in FIG. 4).

In this embodiment, the support device 100 comprises one or more inserting materials selected from the group consisting of LUX foam, high density foam, memory foam, organic cotton batting, and poly foam, shredded memory foam, non-toxic memory foam, micro bead, polyester fiberfill, buckwheat hull, kapok stuffing, and latex stuffing, and any combination of the abovementioned materials. It is to be appreciated that the one or more inserts may also be constructed of a single material or of two or more materials. In some embodiments, the support device comprises only one insert constructed of a single material for the chin rest, body, and arm rest structures. Yet in other embodiments, one component, for example, a chin rest 8, may comprise two or more inserts constructed of various materials.

In embodiments, the support device 100 comprises one or more covers 124. In this embodiment, the support device 100 comprises a cover 124 covering the chin rest 104, the first and second arm rests 106A and 160B, and the body 102. In this embodiment, the cover 124 is constructed of materials selected from the group consisting of polyester knitted jersey, vinyl, PVC mackintosh materials, brushed microfiber, organic cotton with a waterproof barrier, waterproof polyurethane membrane, NaturSoft PU rayon backed upholstery, and any combination of the abovementioned materials. In some embodiments, the cover may further comprise an opening and a waterproof zipper capable of opening and closing the opening. In yet other embodiments, the cover may be replaceable and constructed of disposable materials, including, but not necessarily limited to, tissue, polyester, polypropylene, spunbonded polypropylene, spunlance, and any combination of the abovementioned materials. It is to be appreciated that in yet other embodiments, a support device may be constructed as a one-piece device comprising a chin rest, a body, and an arm rest, wherein the chin rest, the body, and the arm rest are all covered by a first cover. It is also appreciated that in some embodiments, a support device may comprise a first cover covering a chin rest and a body, and a second cover covering an arm rest insert, wherein the first cover and the second cover each include an attaching mechanism configured to attach the arm rest to the body. In such embodiments, patients and physicians may remove the arm rest from the body easily without opening the first cover for the body. In some embodiments, the first and second covers may be constructed of materials selected from the group consisting of polyester knitted jersey, vinyl, PVC mackintosh materials, brushed microfiber, organic cotton with a waterproof barrier, waterproof polyurethane membrane, NaturSoft PU rayon backed upholstery, and any combination of the abovementioned materials. In yet other embodiments, the first and the second covers may be replaceable and constructed of disposable materials, including, but not necessarily limited to, tissue, polyester, polypropylene, spunbonded polypropylene, spunlance, and any combination of the abovementioned materials.

In some embodiments, the support device 100 further comprises an inner cover (not shown in figures) disposed between the cover 124 and the body 102, wherein the inner cover is constructed of any one or more suitable materials, including, but not necessarily limited to, cotton, microfiber, linen, and any combination of the above-mentioned materials.

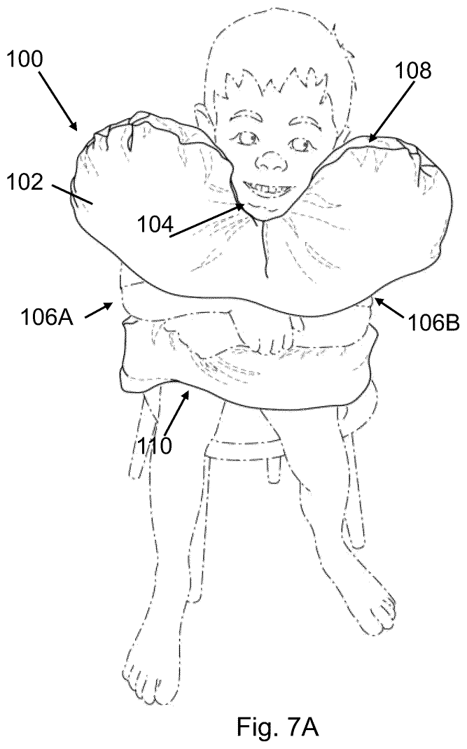

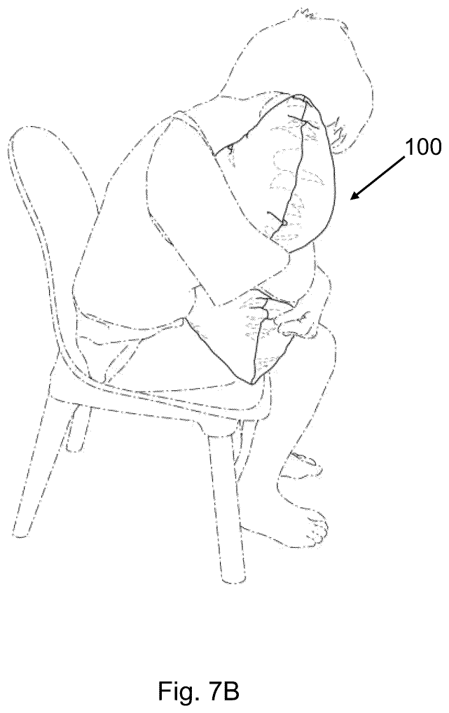

FIGS. 7A and 7B illustrate a user holding the support device 100. Specifically, when holding the support device 100, as shown in FIG. 7A, the user may rest his or her chin on the chin rest 104 and wrap their arms around the body 102, wrapping their arms around the central body of the pillow and/or (if an arm rest 106 is present) resting their arms on the arm rest 106. The user may further place the second end 110 of the body 102 on his or her legs for comfort and support. As shown in FIG. 7B, when using the support device, the user may further curl their upper body to squeeze the support device 100. As described above, in some embodiments, a support device comprises the first cover and a second cover, wherein each of the covers has an attaching mechanism configured to facilitate the attachment and removal of the arm rest to the body. In yet other embodiments, a support device also comprises a pair of attaching mechanisms for handstraps. Besides facilitating the attachment and removal of the handstraps, the attaching mechanism is further configured to allow patients, physicians, nurses, etc. to adjust the vertical and horizontal position of the handstraps. The arm rest attaching mechanism(s) and handstrap attaching mechanism(s) may each be selected from the group consisting of hook-and-loop fasteners (e.g., fasteners sold under the trademark VELCRO®), zippers, snaps, buttons, clasps, and combinations thereof.

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

1. A support device, comprising:
a body comprising:
a front surface;
a back surface spaced from the front surface in a lateral direction;
a top; and
a bottom spaced from the top in a vertical direction;
an arm rest protruding from the front surface of the body along a longitudinal axis;
a chin rest cut into the top of the body along the longitudinal axis; and
a handle.

2. The support device of claim 1, further comprising:
an outer body cover;
a body insert; and
an inner body cover placed between the outer body cover and the body insert.

3. The support device of claim 2, wherein the outer body cover is constructed of any one or more materials selected from the group consisting of polyester knitted jersey, vinyl, PVC mackintosh, microfiber, cotton with waterproof barrier, waterproof polyurethane membrane, PU rayon, and any combination of the abovementioned materials.

4. The support device of claim 2, wherein the body insert is constructed of any one or more materials selected from the group consisting of memory foam, micro bead, polyester fiber refill stuffing, buckwheat hull stuffing, kapok stuffing, latex stuffing, and any combination of the abovementioned materials.

5. The support device of claim 2, wherein the inner body cover is constructed of cotton, microfiber, or a combination thereof.

6. The support device of claim 2, wherein the outer body cover is disposable and constructed of any one or more materials selected from the group consisting of tissue, polyester, polypropylene, spunbonded polypropylene, spunlance, spunbond, and any combination of the abovementioned materials.

7. The support device of claim 1, wherein the handle comprises at least two hand straps attached to the front surface of the support device.

8. The support device of claim 1, wherein a thickness of the body gradually increases from the top to the bottom.

9. The support device of claim 1, wherein a width of the body is between about 14 inches and about 18 inches, and a height of the body is between about 18 inches and about 30 inches.

10. The support device of claim 1, wherein the arm rest further comprises an arm rest insert constructed of any one or more materials selected from the group consisting of LUX foam, polystyrene foam, high density foam, memory foam, cotton batting, and any combination of the abovementioned materials.

11. A support device, comprising:
a body comprising:
a front surface;
a back surface spaced from the front surface in a horizontal direction;
a top; and
a bottom spaced from the top in a vertical direction;
an arm rest protruding from the front surface of the body along a longitudinal axis, wherein the arm rest is removable from the body;
a chin rest cut into the top of the body along the longitudinal axis; and
a handle, comprising two hand straps placed on the front surface of the body.

12. The support device of claim 11, wherein the arm rest is attached to the body by an arm rest attaching mechanism.

13. The support device of claim 12, wherein the arm rest attaching mechanism comprises a first arm rest attaching component placed on the arm rest, and a second arm rest attaching component placed on the body, and
wherein the arm rest attaching mechanism is selected from the group consisting of zipper, a hook and loop material, buttons, snap fasteners, and combinations thereof.

14. The support device of claim 11, wherein each of the hand straps is attached to the body by a handle attaching mechanism, wherein the handle attaching mechanism comprises a first handle attaching component and a second handle attaching component, and wherein the handle rest attaching mechanism is selected from the group consisting of zipper, a hook and loop material, buttons, snap fasteners, and combinations thereof.

15. The support device of claim 10, wherein the body further comprises:
an outer body cover, wherein the outer body cover is disposable and is constructed of any one or more materials selected from the group consisting of polyester knitted jersey, vinyl, PVC mackintosh, microfiber, cotton with waterproof barrier, waterproof polyurethane membrane, PU rayon, and any combination of the abovementioned materials;
a body insert, wherein the body insert is constructed of any one or more materials selected from the group consisting of memory foam, micro bead, polyester fiber refill stuffing, buckwheat hull stuffing, kapok stuffing, latex stuffing, and any combination of the abovementioned materials; and
an inner body cover placed between the outer body cover and the body insert, wherein the inner body cover is constructed from cotton, microfiber, or a combination thereof.

16. A support device, comprising:
a body comprising:
a front surface;
a back surface spaced from the front surface in a lateral direction;
a first end;
a second end spaced from the top in a vertical direction;
a first side; and
a second side spaced form the first side in a longitudinal direction;
at least one arm rest carved out from the first side or the second side of the body along the longitudinal axis; and
a chin rest cut into the top of the body.

17. The support device of claim 16, wherein the at least one arm rest comprises a first arm rest carved out from the first side of the body and a second arm rest carved out from the second side of the body.

18. The support device of claim 16, comprising a cover, wherein the cover is disposable and is constructed of any one or more materials selected from the group consisting of polyester knitted jersey, vinyl, PVC mackintosh, microfiber, cotton with waterproof barrier, waterproof polyurethane membrane, PU rayon, and any combination of the abovementioned materials.

19. The support device of claim 17, comprising an inner cover placed between the cover and the body, wherein the inner cover is constructed from cotton, microfiber, or a combination thereof.

20. The support device of claim 16, wherein a width of the body varies along the vertical direction, wherein the width reaches a maximum at a point between the first end of the body and an upper end of the arm rest.
